(19) United States
(12) Patent Application Publication
(10) Pub. No.: US 2012/0228986 A1
(43) Pub. Date: Sep. 13, 2012

(54) ROTOR FOR ROTATING ELECTRIC MACHINE AND MANUFACTURING METHOD THEREOF

(75) Inventors: Giuseppe MOIOLI, Paderno Dugnano (MI) (IT); Emidio Norcini, Monza (IT); Livio Vignati, Pieve Fissiraga (LO) (IT)

(73) Assignee: ABB S.p.A., Milano (IT)

(21) Appl. No.: 13/413,458

(22) Filed: Mar. 6, 2012

(30) Foreign Application Priority Data
Mar. 9, 2011 (IT) MI2011U000087

(51) Int. Cl. H02K 3/487

(52) U.S. Cl. 310/214

(57) ABSTRACT

A rotor for a rotating electric machine, having at least a pair of cavities with a bottom wall from which a first lateral wall and a second lateral wall extend transversally, wherein each cavity is suitable for receiving therein a respective lateral portion of a winding of the rotor through an insertion opening that extends facing the bottom wall from the first lateral wall to the second lateral wall. The rotor includes blocking means suitable for blocking the lateral portions of the winding in the respective pair of cavities by operatively coupling with coupling means defined in the rotor.

### RELATED APPLICATION(S)

This application claims priority under 35 U.S.C. §119 to Italian Patent Application No. MI2011U000087 filed in Italy on Mar. 9, 2011, the entire content of which is hereby incorporated by reference in its entirety.

### FIELD

The present disclosure relates to an electric machine, such as, a rotor for a rotating electric machine and the manufacturing method for the rotor itself, which offers improved features for the insertion of windings into the rotor.

### BACKGROUND INFORMATION

Rotating electric machines, such as for example electrical motors or generators, are devices that due to their versatility, reliability, and long life, have an increased widespread use in a large number of sectors.

Known rotating electric machines include a rotor suitable for rotating around its axis of rotation. In the rotor, a plurality of cavities, extending for at least a portion of the longitudinal extension of the rotor, are radially defined with respect to the axis of rotation. Windings are inserted into the cavities in order to configure the phases, or poles, of the rotor.

In known implementations, the windings of the rotor can include a set of straps connected in series, and the interior of the cavities made accessible through a cleft that allows the insertion of the straps for the respective windings. The cleft can be sized so that the straps of a winding can be inserted in the respective cavity one at a time.

In practice, a first strap of the winding can initially inserted into the respective cavity through the suitable insertion cleft, and then moved until contacting a wall that defines the cavity itself; then a second strap can be inserted into the cavity through the insertion cleft, and moved towards the first strap, until contacting with it. This same process can be repeated for all other straps of the winding, until the cavity is filled.

Known rotor designs offer the advantage that the structure itself of the cavities of the rotor is suitable for helping to hold the straps inside it, withstanding the centrifugal force applied by the straps themselves during the rotation of the rotor around its axis of rotation.

However, the fact that the straps of the windings have to be inserted first and then moved in the respective cavity one at a time, makes the rotor manufacturing process particularly slow and complex, and therefore expensive.

### SUMMARY

An exemplary rotor of a rotating electric machine for rotating around an axis of rotation is disclosed, the rotor comprising: at least a first cavity and at least a second cavity, which are radially defined relative to said axis of rotation along at least a portion of a longitudinal extension of the rotor along the axis of rotation, said first cavity and said second cavity including a bottom wall from which a first lateral wall and a second lateral wall extend facing each other and transversal with respect to said bottom wall, and configured for receiving therein a first lateral portion and a second lateral portion, respectively, of a winding of the rotor through an insertion opening which extends facing said bottom wall from said first lateral wall to said second lateral wall; and blocking means for blocking the first lateral portion and the second lateral portion of said winding inside the first cavity and the second cavity, respectively, by operatively coupling to respective coupling means defined in the rotor.

An exemplary method of manufacturing a rotor of a rotating electric machine for rotating around an axis of rotation is disclosed, said method comprising: defining at least a first cavity and at least a second cavity radially with respect to said axis of rotation along at least a portion of the longitudinal extension of the rotor along the axis of rotation itself, said at least a first cavity and said at least a second cavity comprising a bottom wall from which a first lateral wall and a second lateral wall extend facing each other and transversal with respect to said bottom wall, said at least a first cavity and said at least a second cavity for receiving therein a first lateral portion and a second lateral portion, respectively, of a winding of the rotor; inserting the first lateral portion and the second lateral portion of said winding inside the first cavity and inside the second cavity, respectively, through an insertion opening of the first cavity and of the second cavity, which extends facing the bottom wall from said first lateral wall to said second lateral wall; and blocking the first lateral portion and the second lateral portion of said winding inside said at least a first cavity and said at least a second cavity through coupling means for operatively coupling to respective coupling means defined in the rotor.

An exemplary rotor of a rotating electric machine for rotating around an axis of rotation is disclosed, the rotor comprising: at least one first cavity for receiving a first lateral portion; at least one second cavity for receiving a second lateral portion; and blocking means for blocking the first lateral portion and the second lateral portion of said winding inside the first cavity and the second cavity, respectively, by operatively coupling to respective coupling means defined in the rotor, wherein said first and second cavities are located radially relative to said axis of rotation along a longitudinal extension of the rotor, said first cavity and said second cavity including a bottom wall, and two lateral walls that extend transversally on opposite edges of said bottom wall, and wherein each of the two lateral walls is configured to receive a winding of the rotor through an insertion opening that extends facing said bottom wall and between the two lateral walls.

### BRIEF DESCRIPTION OF THE DRAWINGS

Characteristics and advantages will become more apparent from the non-exclusive description of an exemplary embodiment of a rotor for a rotating electric machine according to the present disclosure, illustrated for exemplification purposes in the accompanying drawings; wherein:

FIG. 1 is a perspective view of a rotor with its windings inserted into the respective cavities in accordance with an exemplary embodiment;

FIG. 2 is a cross-sectional view of a cavity of the rotor in FIG. 1, with the straps of the respective winding inserted therein and a wedge coupled to it in accordance with an exemplary embodiment; and

FIG. 3 is a schematic diagram of two sections of the rotor in FIG. 1, coupled to the respective windings that define a phase of the rotor in accordance with an exemplary embodiment.

### DETAILED DESCRIPTION

Exemplary embodiments disclosed herein overcome the disadvantage pointed out in the prior art by providing a rotor that specifies a simple, rapid, and economical manufacturing process.

These exemplary embodiments being directed to a rotor for a rotating electric machine, suitable for rotating around an axis of rotation and including at least a first cavity and at least a second cavity, which are radially defined relative to the axis of rotation along at least a portion of the longitudinal extension of the rotor along the axis of rotation itself, said at least a first cavity and said at least a second cavity including a bottom wall from which a first lateral wall and a second lateral wall extend facing each other and transversal with respect to the bottom wall, said at least a first cavity and said at least a second cavity being suitable for receiving therein a first lateral portion and a second lateral portion, respectively, of a winding of the rotor through an insertion opening which extends facing the bottom wall from the first lateral wall to the second lateral wall.

The exemplary rotor includes blocking means suitable for blocking the first lateral portion and the second lateral portion of the winding inside the first cavity and the second cavity, respectively, by operatively coupling to respective coupling means defined in the rotor.

An exemplary manufacturing method of a rotor for a rotating electric machine suitable for rotating around an axis of rotation, as provided in the present disclosure can include defining at least a first cavity and at least a second cavity radially with respect to the axis of rotation along at least a portion of the longitudinal extension of the rotor along the axis of rotation itself, said at least a first cavity and said at least a second cavity having a bottom wall from which a first lateral wall and a second lateral wall extend facing each other and transversal with respect to the bottom wall, said at least a first cavity and said at least a second cavity being suitable for receiving therein a first lateral portion and a second lateral portion, respectively, of a winding of the rotor; inserting the first lateral portion and the second lateral portion of the winding inside the first cavity and inside the second cavity, respectively, through an insertion opening of the first cavity and of the second cavity, which extends facing the bottom wall from the first lateral wall to the second lateral wall.

The exemplary method disclosed herein can also include blocking the first lateral portion and the second lateral portion of the winding inside said at least a first cavity and said at least a second cavity through coupling means suitable for operatively coupling to respective coupling means defined in the rotor.

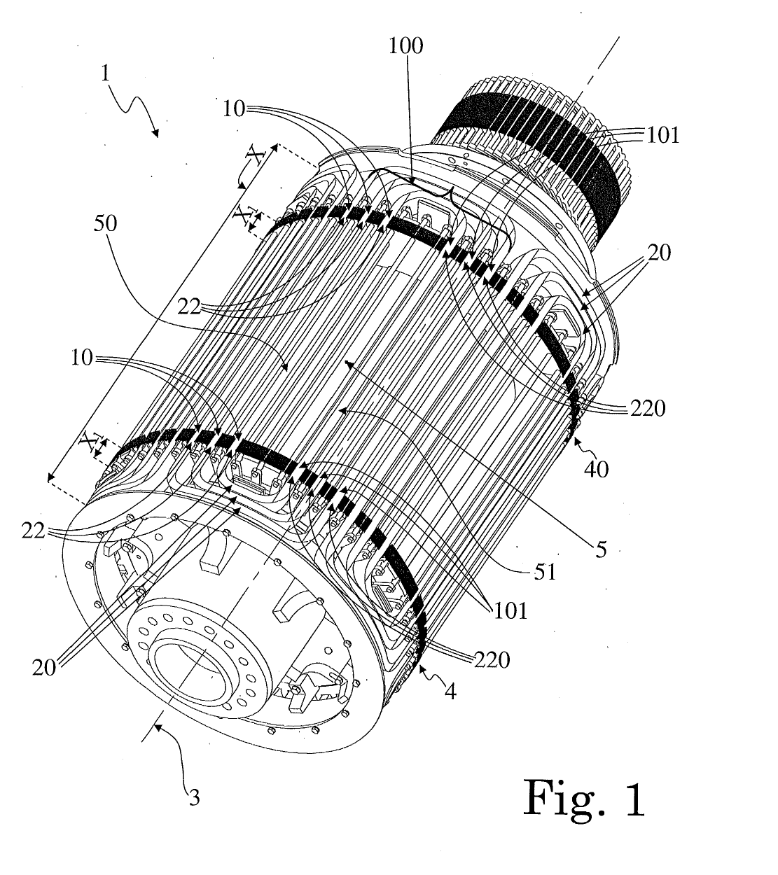

FIG. 1 is a perspective view of a rotor with its windings inserted into the respective cavities in accordance with an exemplary embodiment. The exemplary rotor 1 can be used in a rotating machine such as for instance an electric motor or generator. Rotor 1 is suitable for rotating around its axis of rotation 3 illustrated in FIG. 1.

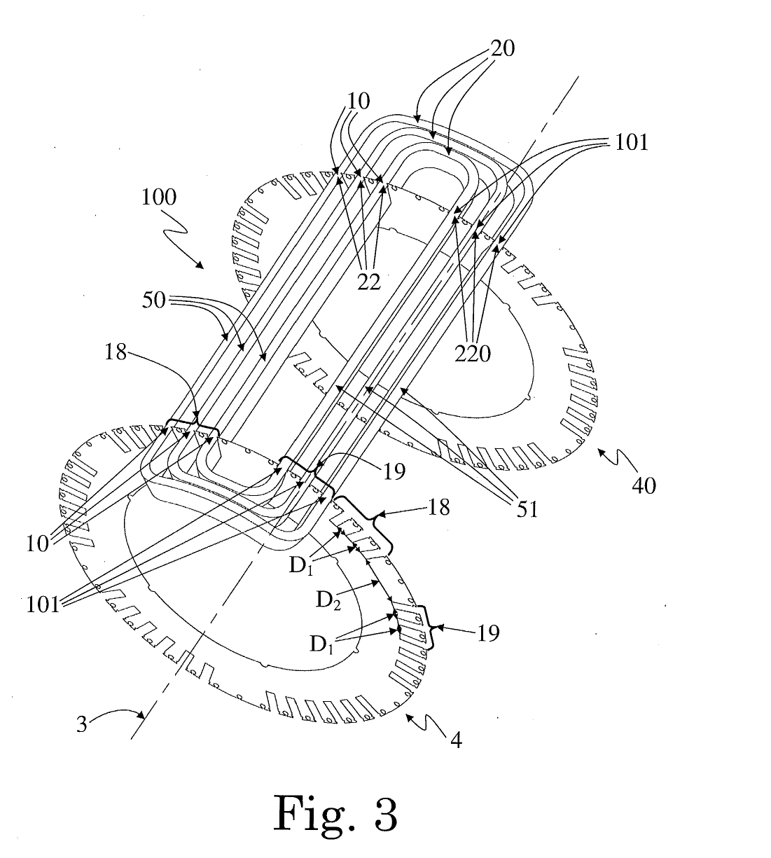

The rotor 1 can include a plurality of cavities radially defined with respect to the axis of rotation 3, along at least a portion of the longitudinal extension of the rotor 1 along the axis of rotation 3 itself, longitudinal portion which is indicated by the reference “X” in the example illustrated in FIG. 1. For simplicity sake, reference will be made in the following description to at least a first cavity 10 and at least a second cavity 101 of said plurality of cavities, which are suitable for receiving therein a first lateral portion 22 and a second lateral portion 220, respectively, of a corresponding winding 20 of rotor 1. In particular, the first lateral portion 22 inserted into a cavity 10 and the second lateral portion 220 inserted into a cavity 101 belong to a first side 50 and a second side 51, respectively, of the winding 20. Once such winding 20 is inserted into the rotor 1, the first side 50 and the second side 51 extend along the axis of rotation 3 of the rotor 1 itself, facing each other (see for example FIG. 1 and FIG. 3).

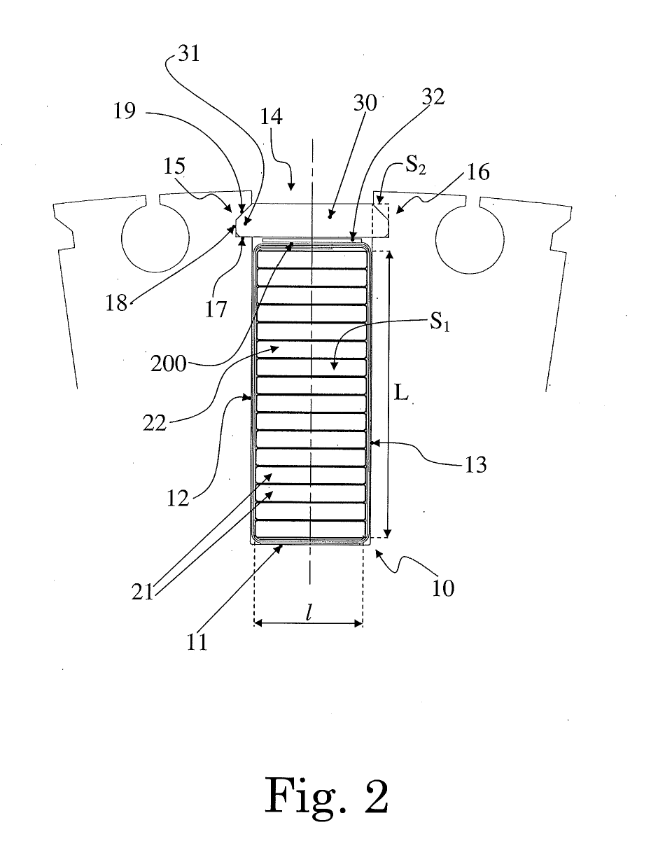

The windings 20 of the rotor 1 can be realized by a set of straps 21 electrically in series, produced by bending a strip of metallic material, such as copper (see for example the straps 21 illustrated in FIG. 2), for example. The set of straps 21 inserted into a respective cavity 10 (or a respective cavity 101) is wrapped by at least a layer of an insulating material 200 (see FIG. 2).

FIG. 2 is a cross-sectional view of a cavity of the rotor in FIG. 1, with the straps of the respective winding inserted therein and a wedge coupled to it in accordance with an exemplary embodiment. The cavity 10 illustrated in detail in FIG. 2, which is structurally the same as a cavity 101, can include a bottom wall 11, from which a first lateral wall 12 and a second lateral wall 13 extend facing each other and transversal with respect to the bottom wall 11.

According to an exemplary embodiment of the present disclosure, the cavities 10, 101 of the rotor 1 are arranged along the longitudinal extension X of the rotor 1 itself in rows of cavities 10 separated from each other and aligned along the axis of rotation 3, and in rows of cavities 101 separated from each other and aligned along the axis of rotation 3. Alignment among cavities in the same row is to be understood as alignment along the direction defined by the axis of rotation 3 of the bottom walls 11, of the first lateral walls 12 and of the second lateral walls 13 of such cavities.

In practice, the cavities 10, 101 of the rotor 1 are defined along portions of the longitudinal extension X of the rotor 1 itself, which are physically separated (e.g., equidistant) from each other. In particular, such longitudinal portions are mounted and fixed on a central body 5 of the rotor 1 (see FIG. 1).

For clarity of visualization, FIG. 1 illustrates a first longitudinal portion 4 and a second longitudinal portion 40 of the rotor 1, each having a longitudinal extension indicated in FIG. 1 by the reference “X1”.

The other longitudinal portions of the rotor 1, not illustrated in FIG. 1, are equivalent to the first longitudinal portion 4 and to the second longitudinal portion 40, and are mounted on the central body 5 equidistant from each other along the longitudinal extension X of the rotor 1, between the first longitudinal portion 4 and the second longitudinal portion 40.

Cavities 10, 101 defined on the different longitudinal portions of the rotor 1 are aligned to each other along the axis of rotation 3. In this way, the first side 50 and the second side 51 of each winding 20 of the rotor 1 are inserted in a corresponding row of cavities 10 and a corresponding row of second cavities 101, respectively.

Alternatively to the illustrated embodiment, the rows of cavities 10, 101 could be substituted by single cavities extending for the entire longitudinal extension X of the rotor 1.

The radial disposition of cavities 10, 101 of the rotor 1, which are defined along the same longitudinal portion of the rotor 1 itself (such as for example the first longitudinal portion 4 and the second longitudinal portion 40 illustrated in FIG. 1) is now considered.

The rotor 1 can include a plurality of phases 100 configured by a certain number of windings 20. For each phase 100 of the rotor 1, cavities 10, 101 defined along the same longitudinal portion of the rotor 1 has a first group of cavities 10 radially adjacent to each other (overall indicated with reference number 18 in the example in FIG. 3) and a second group of cavities 101 radially adjacent to each other (overall indicated with reference number 19 in the example in FIG. 3). In particular, cavities 10 of the first group 18 are suitable for receiving the lateral portions 22 of sides 50 of the windings 20 that configure the respective phase 100, and second cavities 101 of the second group 19 are suitable for receiving the lateral portions 220 of sides 51 of such windings 20.

The minimum distance D1 between cavities 10 adjacent to each other in the first group 18, can be equal to the minimum distance between cavities 101 adjacent to each other in the group 19, is less than the minimum distance D2 between a cavity 10 of the first group 18 and a cavity 101 of the second group 19 radially defined adjacent to each other.

The rotor 1 illustrated in FIG. 1 includes six phases 100, each of them realized by three windings 20. FIG. 3 is a schematic diagram of two sections of the rotor in FIG. 1, coupled to the respective windings that define a phase of the rotor in accordance with an exemplary embodiment. As shown FIG. 3, three windings 20 which realize a phase 100, can be coupled for clarity of visualization to a cross section of the first longitudinal portion 4 and of the second longitudinal portion 40 of the rotor 1. Considering for simplicity, the coupling to the section of the first longitudinal portion 4, the lateral portions 22 of the three windings 20 are inserted into a respective first group of cavities 18, which includes three cavities 10 adjacent and equidistant by the same minimum distance D1; and the lateral portions 220 of such three windings 20 are inserted into a respective second group of cavities 19, which includes three second cavities 101 adjacent and equidistant from each other by the same minimum distance D1. The second group of cavities 19 is adjacent to the first group 18 and separated from it by the minimum distance D2.

In an exemplary embodiment, the number of phases 100 of the rotor 1 and the number of windings 20 that configure such phases 100 may be different from the illustrated one, according to the specifications of the application of the rotor 1; and hence also the number of cavities 10 of the first group 18 and the number of cavities 101 of the second group 19 may be different from the illustrated one, according to the different configuration of the phases 100.

For simplicity sake the following description will refer to cavities 10, in particular to the cavity 10 illustrated in the example in FIG. 2. The characteristics described for the cavity 10, as well as the interaction of such cavity 10 with other parts of the rotor 1, are to be understood as valid for all the cavities of the rotor 1.

In an exemplary rotor 1 as described in the present disclosure, the cavities 10 are suitable for receiving therein the respective lateral portions 22 of windings 20 through an insertion opening 14 that extends facing the bottom wall 11 from the first lateral wall 12 to the second lateral wall 13. An exemplary embodiment of cavity 10 is illustrated in FIG. 2.

In an exemplary embodiment disclosed herein, the cavity 10 is suitable for receiving therein the respective lateral portion 22 of the winding 20 so that section S1 (illustrated in FIG. 2) of such lateral portion 22 (transversal to axis of rotation 3) has its bigger side L transversal to the bottom wall 11 of the cavity 10, and its smaller side I parallel to the bottom wall 11.

The example illustrated in FIG. 2 shows how straps 21 of the winding 20 are stacked one on top of each other, with the bigger side of the cross section of each strap 21 arranged parallel to the bottom wall 11.

In another exemplary embodiment of the present disclosure, cavities 10 in the rotor 1 may be suitable for receiving therein the respective lateral portions 22 of the windings 20 so that section S1 of such lateral portions 22 has its bigger side L parallel to the bottom wall 11 of the cavity 10, and its smaller side I transversal to the bottom wall 11.

In this embodiment, straps 21 of the winding 20 are inserted into the cavity 10 adjacent to one another, with the smaller side of the cross section of each strap 21 resting on the bottom wall 11.

Advantageously, the rotor 1 according to the present disclosure includes blocking means suitable for blocking the lateral portions 22 of its windings 20 inside the respective cavities 10 during the rotation of the rotor 1 around its axis of rotation 3, in spite of the presence of the insertion openings 14.

According to a exemplary embodiment, the blocking means of the rotor 1 are suitable for operatively coupling to respective coupling means defined in the rotor 1, such as inside cavities 10.

Upon such coupling, the blocking means can cover at least a portion of the insertion opening 14 of the cavities 10.

According to an exemplary embodiment, the blocking means includes at least a first insertion recess 15 and a second insertion recess 16, which are defined along the first lateral wall 12 and the second lateral wall 13 of the cavities 10, respectively, lengthwise the axis of rotation 3.

The first insertion recess 15 and the second insertion recess 16 are suitable for receiving respective portions 31 of a wedge 30 to cover insertion opening 14.

The first insertion recess 15 and the second insertion recess 16 advantageously have a cross section S2 (illustrated in FIG. 2), transversal with respect to the axis of rotation 3, with a substantially trapezoidal shape, according to a configuration known as “dovetail”. In particular, as shown in FIG. 2, the first insertion recess 15 and the second insertion recess 16 can be defined by: a lower edge 17 substantially parallel to the bottom wall 11 of the cavity 10, by a central edge 18 that extends transversely from the lower edge 17, and an upper edge 19 that extends from the central edge 18 tilt to face towards the lower edge 17. Portions 31 of the wedge 30 have parts configured for contacting with the upper edge 19 when inserting the wedge 30 into the first insertion recess 15 and the second insertion recess 16 respectively.

A sub-wedge 32 is inserted into the cavity 10 between the wedge 30 and the lateral portion 22 of the winding 20. In particular, in the example in FIG. 2, the sub-wedge 32 is positioned over the insulating layer 200 that wraps the stack of straps 21 inserted into the cavity 10 and performs the double function of preventing damages of the insulating layer 200 during the longitudinal sliding of the wedge 30 into the first insertion recess 15 and the second insertion recess 16, and helping to hold the wedge 30 blocked in its insertion position in the first insertion recess 15 and in the second insertion recess 16 during the rotation of the rotor 1.

In another exemplary embodiment of the present disclosure a manufacturing method of the rotor 1, can include defining at least a first cavity 10 and at least a second cavity 101 in the rotor 1, according to the exemplary embodiments discussed above and illustrated in Figures.

In particular, according to another exemplary embodiment of the rotor 1, the cavities 10, 101 are arranged in rows of cavities 10, 101 separated and aligned along the axis of rotation 3, as in the examples previously described and illustrated in Figures.

In an exemplary embodiment disclosed herein the manufacturing method of the rotor 1 further can also include inserting the first lateral portion 22 and the second lateral portion 220 of a winding 20 of the rotor 1 into said at least a first cavity 10 and said at least a second cavity 101, respectively, through the insertion opening 14 of the cavities 10, 101 themselves.

The exemplary inserting step of the manufacturing method can include defining said at least a first cavity 10 and said at least a second cavity 101 to be suitable for receiving the first lateral portion 22 and the second lateral portion 220 of the winding 20, such that the section S1 of the first lateral portion 22 and of the second lateral portion 220 (transversal to the axis of rotation 3) has its bigger side L transversal to the bottom wall 11, and its smaller side I parallel to the bottom wall 11, as is the case in the examples previously described and illustrated in Figures (see in particular FIG. 2).

The exemplary manufacturing method of the present disclosure can also include blocking the first lateral portion 22 and the second lateral portion 220 of the winding 20 inside the first cavity 10 and the second cavity 101, respectively, through blocking means suitable for operatively coupling to respective coupling means defined in the rotor 1, such as in cavities 10, 101.

Upon such coupling, the blocking means cover at least a portion of the insertion opening 14.

The exemplary blocking step of the manufacturing method can include defining at least a first insertion recess 15 and a second insertion recess 16 along at least a portion of the first lateral wall 12 and along at least a portion of the second lateral wall 13, respectively; and step c) includes inserting respective portions 31 of the wedge 30 into the first insertion recess 15 and the second insertion recess 16 to cover the insertion opening 14, as is the case in the examples previously described and illustrated in Figures (see in particular FIG. 2).

In step a) the first insertion recess 15 and the second insertion recess 16 can be defined to have a section S2 (transversal to the axis of rotation 3) with a substantially trapezoidal shape, according to the examples previously described and illustrated in Figures (see in particular FIG. 2).

Under experimentation, it has been verified that the rotor 1 according to the present disclosure and the relative manufacturing method fully achieve the predefined objective. In particular, the insertion opening 14 enables the full insertion of the set of straps 21 into the respective cavity of the rotor 1, insertion which occurs in a single manufacturing step without the need, after this step, to move the straps 21 in any way inside the cavity itself.

The insertion of the windings 20 into the respective cavities of the rotor 1 is therefore particularly quick, easy and cheap.

The blocking means of the rotor 1, such as the wedge 30 in the illustrated examples, are suitable for conveniently holding the straps 21 of the windings 20 blocked inside the respective cavities of the rotor 1, which due to the centrifugal force exerted on them during the rotation of the rotor 1 around its axis of rotation 3, are pushed to exit from the cavities themselves through the insertion openings 14.

In particular, the “dovetail” configuration described for the first insertion recess 15 and for the second insertion recess 16 enable the wedge 30 to better withstand the centrifugal force exerted by the straps 21 during the rotation of the rotor 1.

The exemplary embodiment of the rotor 1 (where the cross section S1 of the lateral portions 22, 220 of the windings 20 has its bigger side L transversal to the bottom wall 11) enables to easily insert the stack of straps 21 into the respective cavities of the rotor, and blocking such stack inside during the rotation of the rotor 1.

In particular, the blocking means, such as the wedge 30, should withstand the pushing of the straps 11 by covering the insertion opening 14 with an extension from the first lateral wall 12 to the second lateral wall 13 smaller than the extension foreseen in the alternative embodiment of the rotor 1 (where the cross section S1 of the lateral portions 22, 220 of the windings 20 has the bigger side L parallel to the bottom wall 11).

The solutions described are susceptible to numerous modifications and variations, all within the scope of the present disclosure. For example, alternatively to the examples described and illustrated in Figures, the blocking means for the cavity 10, 101 of the rotor 1 may be suitable for operatively coupling to respective coupling means defined in portions of the rotor included between the cavity 10, 101 itself and another two cavities 10, 101 positioned adjacent to it in the rotor 1. For example, the wedge 30 may be coupled to respective coupling recesses defined in the rotor 1 outside cavity 10, near to the first lateral wall 12 and the second lateral wall 13.

Furthermore, the blocking means may be designed differently than the wedge 30 used in the examples illustrated in Figures. For example, the cavities 10, 101 of the rotor 1 may be coupled to tie-rods that partially lock the insertion openings 14 to lock the straps 21 of the windings 20 inside them.

Finally, all details can be replaced by other equivalent technical elements. In practice, the type of materials within the scope of the applications described above, as well as the dimensions, may be of any kind according to the specifications and the state of the art.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A rotor for a rotating electric machine, suitable for rotating around an axis of rotation, comprising:
at least a first cavity and at least a second cavity, which are radially defined relative to said axis of rotation along at least a portion of a longitudinal extension of the rotor along the axis of rotation, said first cavity and said second cavity including a bottom wall from which a first lateral wall and a second lateral wall extend facing each other and transversal with respect to said bottom wall, and configured for receiving therein a first lateral portion and a second lateral portion, respectively, of a winding of the rotor through an insertion opening which extends facing said bottom wall from said first lateral wall to said second lateral wall; and
blocking means for blocking the first lateral portion and the second lateral portion of said winding inside the first cavity and the second cavity, respectively, by operatively coupling to respective coupling means defined in the rotor.

2. The rotor according to claim 1, wherein said coupling means comprises at least a first insertion recess and a second insertion recess, which are defined along at least a portion of said first lateral wall and along at least a portion of said second lateral wall, respectively, and which are configured for receiving respective portions of said blocking means.

3. The rotor according to claim 2, wherein said first insertion recess and said second insertion recess have a section transversal relative to said axis of rotation with a substantially trapezoidal shape.

4. The rotor according to claim 1, wherein said blocking means comprise at least a wedge configured for covering the insertion opening of said at least a first cavity, and at least a wedge for covering the insertion opening of said at least a second cavity.

5. The rotor according to claim 1, wherein said at least a first cavity and said at least a second cavity are configured for receiving the first lateral portion and the second lateral portion, respectively, of said winding, in such a way that a section of the first lateral portion and of the second lateral portion transversal to said axis of rotation has a bigger side transversal to the bottom wall of the first cavity and the second cavity, respectively.

6. The rotor according to claim 1, wherein said at least a first cavity comprises at least a row of first cavities separated from each other and aligned along said axis of rotation, and wherein said at least a second cavity comprises at least a row of second cavities separated from each other and aligned along said axis of rotation.

7. The rotor according to claim 1,wherein said at least a first cavity comprises at least a first group of cavities radially defined adjacent to each other in said at least a portion of the longitudinal extension of the rotor, and wherein said at least a second cavity comprises at least a second group of cavities radially defined adjacent to each other in said at least a portion of the longitudinal extension of the rotor, wherein the minimum distance between first cavities adjacent in the first group of cavities and the minimum distance between second cavities adjacent in the second group of cavities is less than the minimum distance between a first cavity of the first group of cavities and a second cavity of the second group of cavities, which are radially defined adjacent to each other in said at least a portion of the longitudinal extension of the rotor.

8. A rotating electric machine comprising a rotor according to claim 1.

9. A method of manufacturing a rotor of a rotating electric machine for rotating around an axis of rotation, said method comprising:
defining at least a first cavity and at least a second cavity radially with respect to said axis of rotation along at least a portion of the longitudinal extension of the rotor along the axis of rotation itself, said at least a first cavity and said at least a second cavity comprising a bottom wall from which a first lateral wall and a second lateral wall extend facing each other and transversal with respect to said bottom wall, said at least a first cavity and said at least a second cavity for receiving therein a first lateral portion and a second lateral portion, respectively, of a winding of the rotor;
inserting the first lateral portion and the second lateral portion of said winding inside the first cavity and inside the second cavity, respectively, through an insertion opening of the first cavity and of the second cavity, which extends facing the bottom wall from said first lateral wall to said second lateral wall; and
blocking the first lateral portion and the second lateral portion of said winding inside said at least a first cavity and said at least a second cavity through coupling means for operatively coupling to respective coupling means defined in the rotor.

10. The manufacturing method according to claim 9, wherein said defining step comprises defining at least a first insertion recess and a second insertion recess along at least a portion of said first lateral wall and along at least a portion of said second lateral wall, respectively; and wherein blocking said step comprises inserting respective portions of a wedge into said first insertion recess and said second insertion recess.

11. The method according to claim 10, wherein in said defining step the first insertion recess and the second insertion recess are defined to have a section transversal relative to said axis of rotation with a substantially trapezoidal shape.

12. The method according to claim 9, wherein said defining step comprises defining said at least a first cavity and said at least a second cavity so that they are suitable for receiving the first lateral portion and the second lateral portion, respectively, of said winding in such a way that a section of the first lateral portion and of the second lateral portion transversal to said axis of rotation has a bigger side transversal to the bottom wall of the first cavity and the second cavity, respectively.

13. A rotor for a rotating electric machine, suitable for rotating around an axis of rotation, comprising:
at least one first cavity for receiving a first lateral portion;
at least one second cavity for receiving a second lateral portion; and
blocking means for blocking the first lateral portion and the second lateral portion of said winding inside the first cavity and the second cavity, respectively, by operatively coupling to respective coupling means defined in the rotor,
wherein said first and second cavities are located radially relative to said axis of rotation along a longitudinal extension of the rotor, said first cavity and said second cavity including a bottom wall, and two lateral walls that extend transversally on opposite edges of said bottom wall, and
wherein each of the said lateral walls is configured to receive a winding of the rotor through an insertion opening that extends facing said bottom wall and between the two lateral walls.

14. The rotor according to claim 13, wherein said coupling means comprises at least a first insertion recess and a second insertion recess, which are defined along at least a portion of each of said two lateral walls.

15. The rotor according to claim 14, wherein the first insertion recess and said second insertion recess are configured for receiving respective portions of said blocking means.

16. The rotor according to claim 14, wherein said first insertion recess and said second insertion recess have a section transversal relative to said axis of rotation with a substantially trapezoidal shape.

17. The rotor according to claim 13, wherein the at least one first cavity and the at least one second cavity extend in a lengthwise direction along the axis of rotation of the rotor.
